(19) United States
(12) Patent Application Publication
(10) Pub. No.: US 2003/0056749 A1
(43) Pub. Date: Mar. 27, 2003

(54) Hybrid air engine

(76) Inventor: Nicholas G. Beckertgis, Sheboygan, WI (US)

Correspondence Address: Donald J. Ersler, 725 Garvens Avenue, Brookfield, WI, 53005, US

(21) Appl. No.: 09/960,147

(22) Filed: Sep. 21, 2001

(51) Int. Cl. F02B 19/10

(52) U.S. Cl. 123/292; 123/258; 123/275

(57) ABSTRACT

A hybrid air engine includes an engine block, a head with at least one precombustion chamber (head), at least one intake injector, at least one exhaust valve, a routing manifold, and an engine control module. The at least one intake injector, and the at least one exhaust valve are retained by the head. The precombustion chamber formed in the head includes a spark plug and a precombustion injector. A source of compressed air and a source for fuel is supplied to the routing manifold. The routing manifold directs the flow of the compressed air and fuel to the at least one intake injector and at least one precombustion injector. The engine control module controls the operation of the at least one intake injector, at least one exhaust valve, and other engine components.

### BACKGROUND OF THE INVENTION

1. Field of the Invention

The present invention relates generally to engines and more more specifically to a hybrid air engine which not only uses compressed air as a fuel source, but is also capable of utilizing a small amount of fuel to increase the power thereof.

2. Discussion of the Prior Art

For the past forty years, there has been and continues to be numerous concerns over the increasing reliance on the internal combustion engine as a source of mechanical power. In the past, the government and related industries have taken steps to increase efficiency and decrease air pollution of the internal combustion engine. However, there appears to be a lack of emphasis on the development of new engine types.

Air and compressed air engines have been recently viewed with new interest due to their economic and nonpollution operation. Over the past 90 years, air and compressed air engines have been constructed in various forms. However, air and compressed air engines have the drawback of reduced power output compared to a fuel burning internal combustion engine.

Accordingly, there is a clearly felt need in the art for a hybrid air engine which provides more power than air or compressed air engines while using a minimal amount of combustible fuel.

### SUMMARY OF THE INVENTION

The present invention provides a hybrid air engine which uses a minimal amount of combustible fuel (fuel) to increase the power output. The hybrid air engine includes an engine block, a head with at least one precombustion chamber (head), at least one precombustion injector, at least one intake injector, at least one exhaust valve, a routing manifold, and an engine control module. The engine block includes at least one piston, at least one connecting rod, and a crankshaft. The at least one piston reciprocates via the crankshaft and connecting rod. The engine block is similar to that of an internal combustion engine. The at least one intake injector and the at least one exhaust valve are attached to the head. Each precombustion chamber formed in the head includes a spark plug, and a precombustion injector.

The intake injector preferably includes a fuel injector and an intake for air. Preferably, the fuel injector is a center solenoid for the injection of compressed air and fuel. Preferably, a pair of outer solenoids are formed on an outside of a center solenoid chamber. The pair of outer solenoids open and close a pair of semi-circular valves which allow atmospheric air to be injected into the cylinder. The exhaust valve preferably utilizes the same design as the intake injector. Exhaust gases flow through the center solenoid chamber and cool air is injected through the air passage to cool the exhaust port.

The routing manifold receives compressed air from at least one air pump and fuel from a fuel pump. If the engine has more than one cylinder, the routing manifold distributes compressed air and fuel to each cylinder. The routing manifold preferably includes outlet valves for controlling the flow of compressed air and fuel. The compressed air and fuel are supplied to the at least one intake injector and the at least one precombustion injector. The fuel is not supplied to the at least one intake injector, or to the at least one precombustion injection unless needed. The engine control module controls the operation of the intake injectors, precombustion injectors, exhaust valves, and the spark plugs.

The operation of the hybrid air engine is similar to that of a four cycle internal combustion engine. The cylinder is preferably filled with compressed air, atmospheric air and fuel (if needed) on the intake cycle as the piston is on a downward stroke. The piston moves upward to compress the air and fuel mixture. While the cylinder is being filled with air and possibly fuel; the precombustion chamber is being filled with compressed air and possibly fuel. As the piston reaches a top of a compression stroke, the contents of the precombustion chamber are ignited with the spark plug and the precombustion injector is opened to the cylinder. The ignited mixture from the precombustion chamber ignites the contents of the cylinder. The piston is pushed downward by the ignition on the power stroke. The exhaust valve preferably opens at the bottom of the power stroke. The burned mixture in the cylinder is pushed out as the piston strokes upward on the exhaust stroke. Preferably, the precombustion chamber is filed with compressed air and possibly fuel during the exhaust stroke.

Accordingly, it is an object of the present invention to provide a hybrid air engine which operates cleaner than an internal combustion engine.

Finally, it is another object of the present invention to provide a hybrid air engine which provides more power than air or compressed air engines while using a minimal amount of combustible fuel.

These and additional objects, advantages, features and benefits of the present invention will become apparent from the following specification.

### BRIEF DESCRIPTION OF THE DRAWINGS

FIG. 1 is a cross sectional view of a head of a hybrid air engine in accordance with the present invention.

FIG. 2 is an enlarged cross sectional view of an intake injector or an exhaust valve of a hybrid air engine disclosing solenoid valves in accordance with the present invention.

FIG. 3 is an enlarged cross sectional view of an intake injector or an exhaust valve rotated 90 degrees from FIG. 2 of a hybrid air engine in accordance with the present invention.

FIG. 4 is an enlarged top view of an intake injector or an exhaust valve of a hybrid air engine in accordance with the present invention.

FIG. 5 is an enlarged bottom view of an intake injector or an exhaust valve of a hybrid air engine in accordance with the present invention.

FIG. 6 is an enlarged cross sectional view of a precombustion injector of a hybrid air engine disclosing a side port thereof in accordance with the present invention.

FIG. 7 is a schematic diagram of a hybrid air engine in accordance with the present invention.

FIG. 8 is an enlarged schematic diagram of a routing manifold of a hybrid air engine in accordance with the present invention.

FIG. 9 is a cross sectional view of a hybrid air engine during an intake stroke in accordance with the present invention.

FIG. 10 is a cross sectional view of a hybrid air engine during an ignition stroke in accordance with the present invention.

FIG. 11 is a cross sectional view of a hybrid air engine during a power stroke in accordance with the present invention.

FIG. 12 is a cross sectional view of a hybrid air engine during an exhaust stroke in accordance with the present invention.

### DETAILED DESCRIPTION OF THE PREFERRED EMBODIMENTS

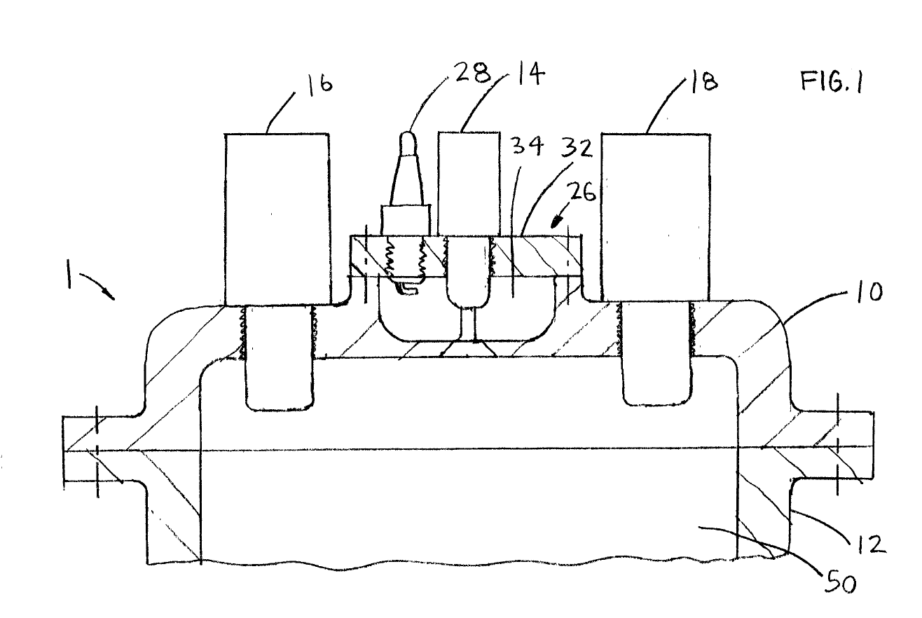

With reference now to the drawings, and particularly to FIG. 1, there is shown a cross sectional view of a head with at least one precombustion chamber 10 (head 10) mounted on the engine block 12 of a hybrid air engine 1. With reference to FIG. 7, the hybrid air engine 1 preferably includes the head 10, the engine block 12, at least one precombustion injector 14, at least one intake injector 16, at least one exhaust valve 18, a routing manifold 20 an engine control module 22. The engine block 12 includes at least one piston 24, at least one connecting rod, and a crankshaft. The engine block 12 is similar to that of an internal combustion engine. The at least one intake injector 16 and the at least one exhaust valve 18 are attached to the head 10. The precombustion chamber 26 of the head 10 includes a spark plug 28, the at least one precombustion injector 14 and a cover plate 32. A precombustion cavity 34 is formed in a top of the head 10 and sealed with the cover plate 32.

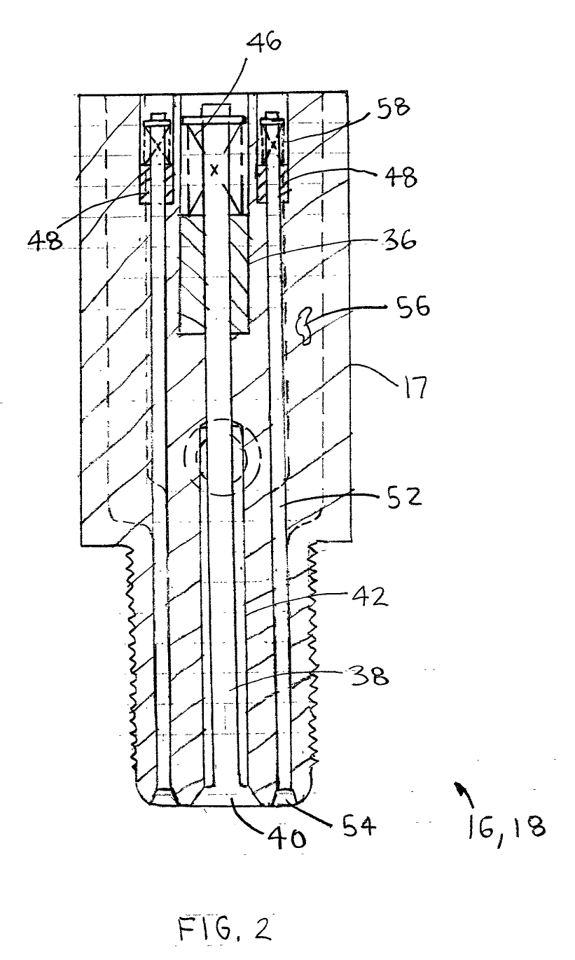

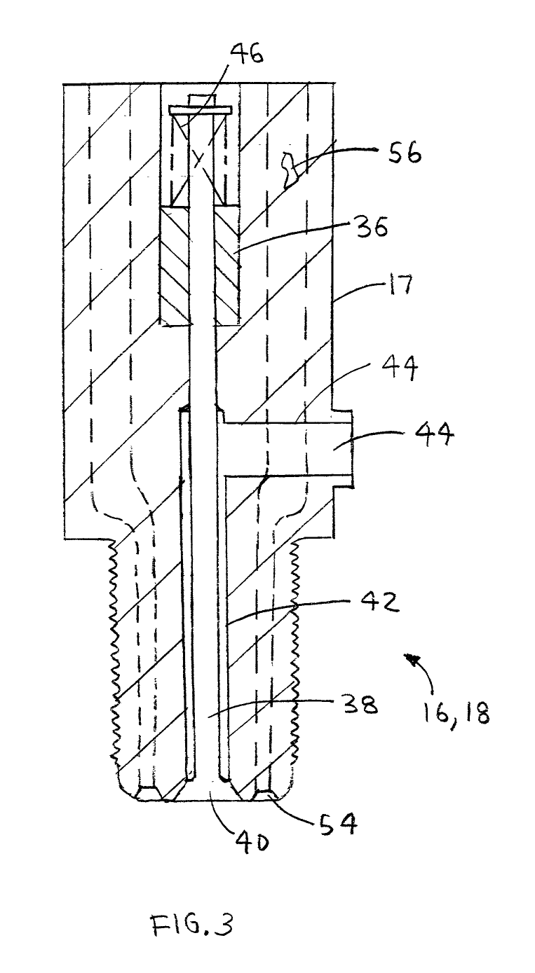

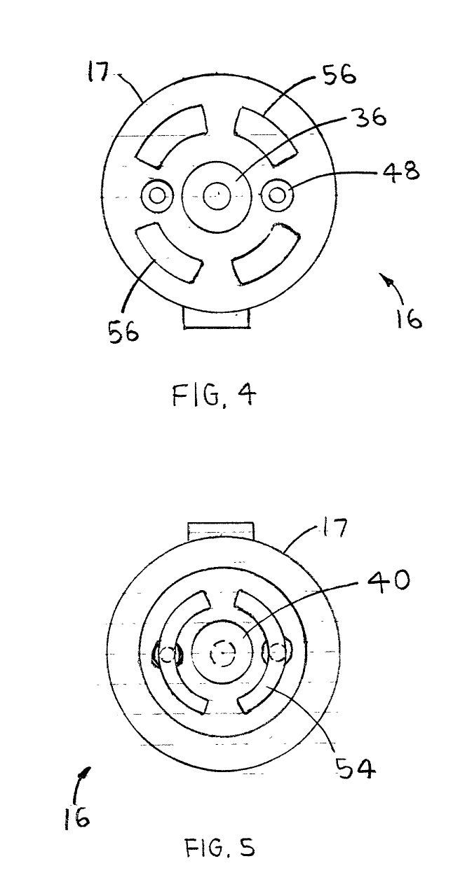

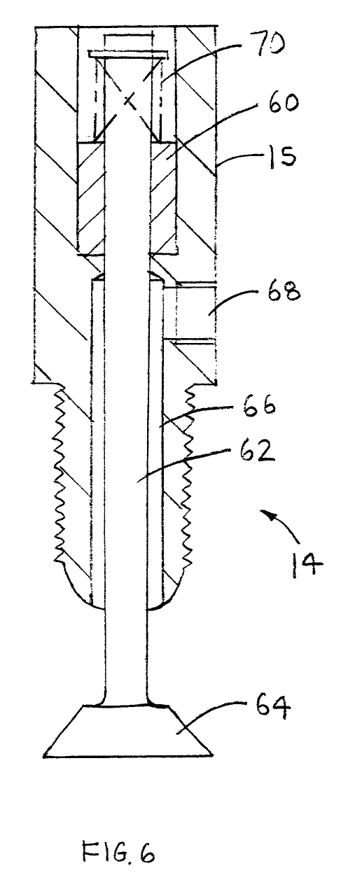

With reference to FIGS. 2-5, each intake injector 16 preferably includes a fuel injector and an intake for fresh air. The fuel injector and the intake for fresh air are contained within an injector body 17. Preferably, threads are formed on substantially a bottom of the injector body 17 such that each intake injector 16 may be threaded into the head 10. However, a separate fuel injector and air intake may be used as is common in prior art internal combustion engines. Each intake injector 16 includes a center solenoid 36 for the injection of compressed air and fuel. A bottom of a center solenoid rod 38 is terminated with a valve end 40. A fuel passage 42 allows compressed air and fuel entering a side port 44 to flow past the solenoid rod 38 and out of each intake injector 16 when the center solenoid 36 is energized. The valve end 40 is retained against a bottom of the fuel passage 42 with a return spring 46.

Each intake injector 16 includes a pair of outer solenoids 48 for the intake of fresh air. The pair of outer solenoids 48 are formed on either side of the center solenoid 36. A bottom of an outer solenoid rod 52 is terminated with a semi-circular valve end 54. The outer solenoid rod 52 may be terminated with other valves having a curved perimeter besides the semi-circular valve end 54. At least one air passage 56 per outer solenoid 48 is formed through the injector body 17. Preferably, atmospheric air enters an air cleaner before entering the air passage 56. The at least one air passage 56 allows fresh air to flow into the cylinder 50 when the outer solenoids 48 are energized. The semi-circular valve end 54 is retained against a bottom of the at least one air passage 56 with a return spring 58.

The exhaust valve 18 preferably has the same design as the intake injector 16. Exhaust gases are removed through the fuel passage 42 and the side port 44 when the center solenoid 36 is energized. Cool air is preferably injected through the at least one air passage 56 into the cylinder 50 by energizing the outer solenoids 48 as exhaust gases exit the side port 44. Other methods of removing exhaust gases from the cylinder 50 may also be used. Other methods of cooling the exhaust valve 18 may also be used.

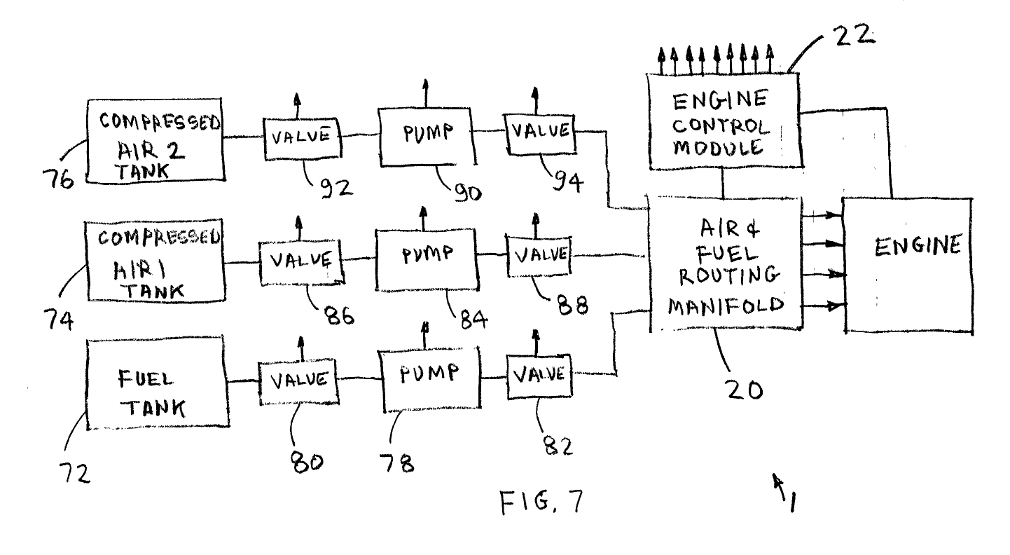

With reference to FIG. 6, the precombustion injector 14 includes an injector body 15 and a precombustion solenoid 60. Preferably, threads are formed on substantially a bottom of the injector body 15 such that the intake injector 16 may be threaded into the cover plate 32. A bottom of a precombustion solenoid rod 62 is terminated with a valve end 64. A fuel passage 66 allows compressed air and fuel entering a side port 68 to flow past the solenoid rod 62 and into the precombustion cavity 34. Preferably during the exhaust stroke, compressed air and optional fuel are injected into the precombustion cavity 34 from the routing manifold 20. Later during the ignition cycle, the compressed air or compressed air and fuel mixture is ignited with the spark plug 28 and the precombustion solenoid 60 is energized which results in an ignited mixture entering the cylinder 50 and igniting the mixture therein. The precombustion valve end 64 is retained against a bottom of the head 10 with a return spring 70.

The routing manifold 20 preferably includes at least three inlets and at least two outlets. The at least three inlets are preferably supplied with fuel from a fuel tank 72, compressed air from a first compressed air tank 74, and compressed air from a second compressed air tank 76. The hybrid air engine 1 will also work with only one source of compressed air. A fuel pump 78 draws fuel from the fuel tank 72 and forces the fuel into the routing manifold 20. Preferably, a fuel input valve 80 controls the flow of fuel into the fuel pump 78 and a fuel output valve 82 controls the flow of fuel into the routing manifold 20.

A first air pump 84 draws compressed air from the first compressed air tank 74 and forces the compressed air into the routing manifold 20. Preferably, a first air input valve 86 controls the flow of compressed air into the first air pump 84 and a first air output valve 88 controls the flow of the compressed air into the routing manifold 20. A second air pump 90 draws compressed air from the second compressed air tank 76 and forces the compressed air into the routing manifold 20. Preferably, a second air input valve 92 controls the flow of compressed air into the second air pump 90 and a second air output valve 94 controls the flow of the compressed air into the routing manifold 20. The engine control module 22 controls the operation of the valves and pumps.

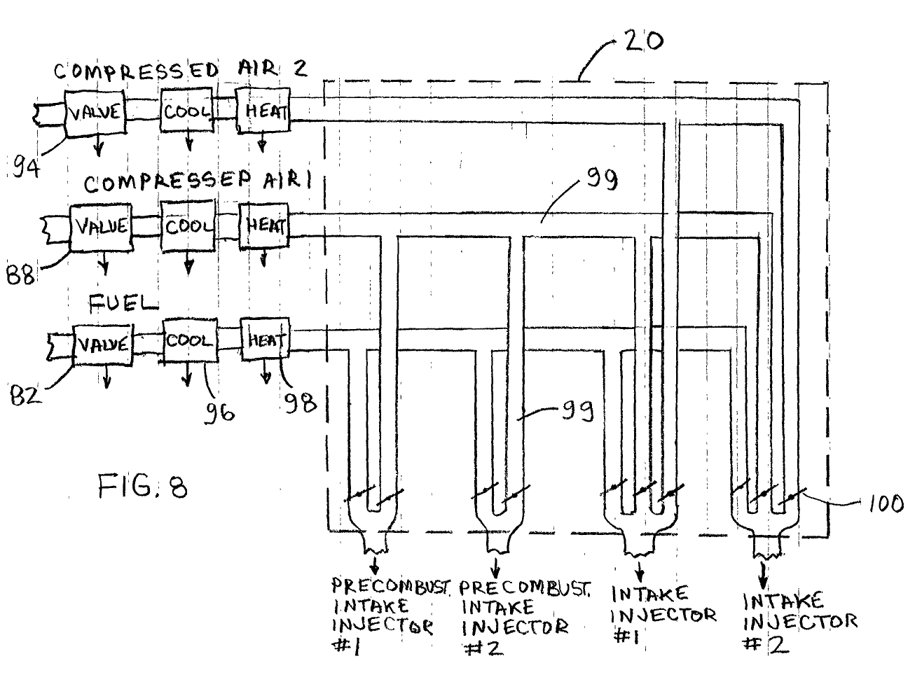

FIG. 8 shows a schematic diagram of the routing manifold 20. The routing manifold 20 is shown with the capability of supplying an engine having two cylinders. However, the routing manifold 20 may be configured to supply an engine having one or more cylinders. Preferably, a cooler unit 96 and a heater unit 98 are secured to each inlet of the routing manifold 20. The cooler unit 96 and the heater unit 98 allow the temperature of the fuel or compressed air to be increased or decreased. The routing manifold 20 preferably receives fuel from the fuel tank 72, compressed air from the first compressed air tank 74, and compressed air from the second compressed air tank 76. The fuel and compressed air is distributed to two precombustion injectors and two intake injectors through a series of passages 99. The fuel and compressed air are preferably mixed at the outlets of the routing manifold 20. The mixing of the fuel and compressed air is implemented with a plurality of outlet valves 100. The actuation of the outlet valves 100 is controlled by the engine control module 22. Fuel is not supplied to the at least one intake injector 16 or the precombustion injector 14 unless needed. The fuel/air ratio is dependent upon the power output required from the engine.

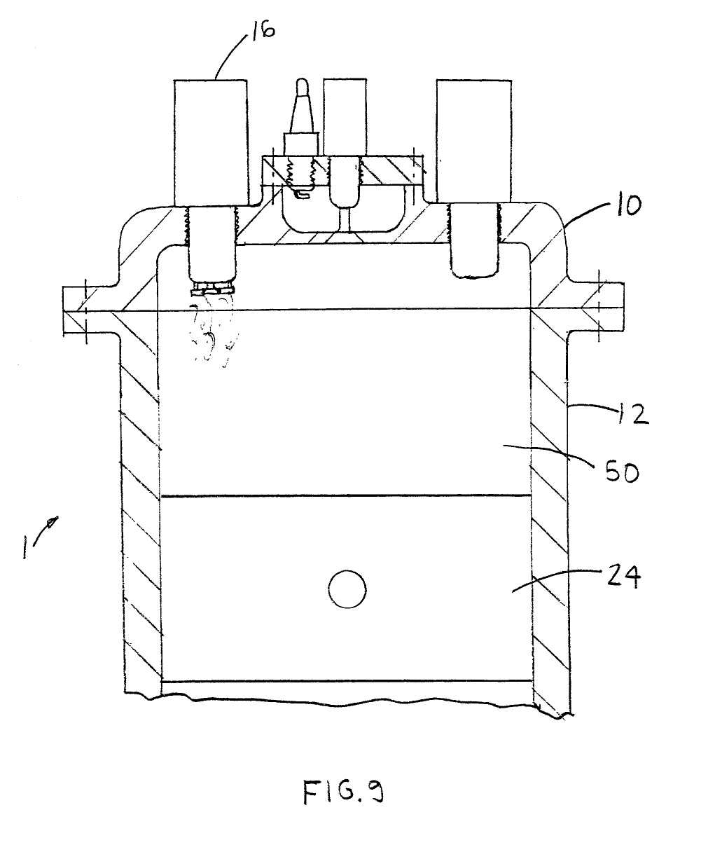

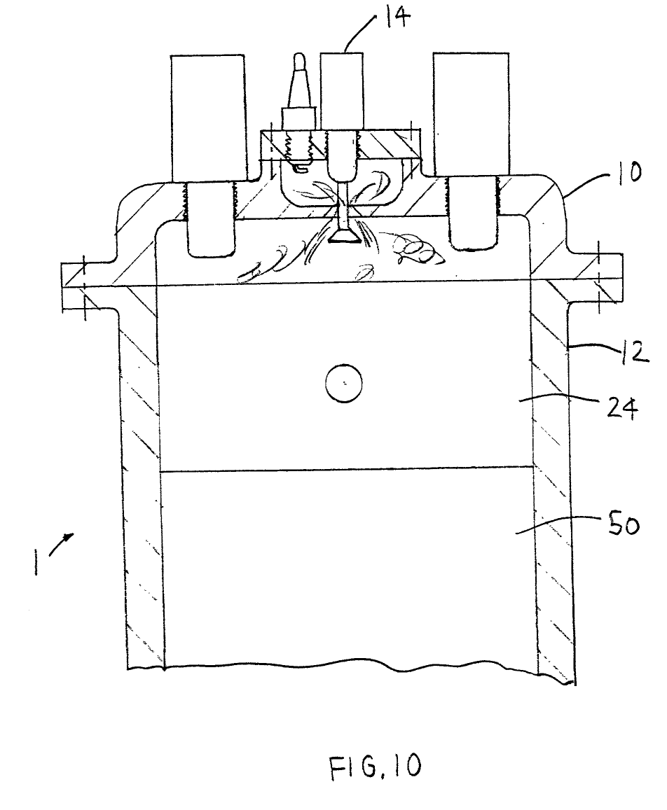

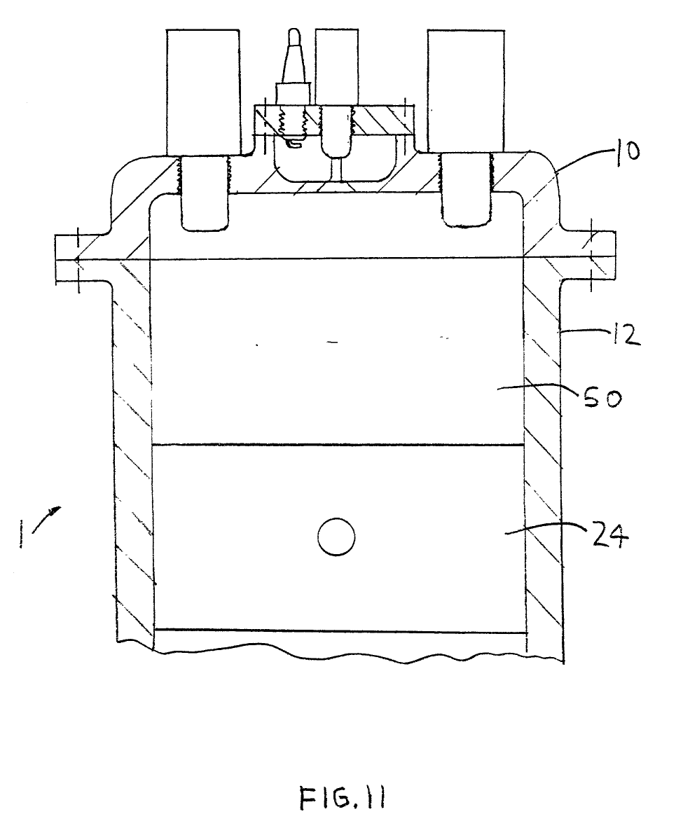

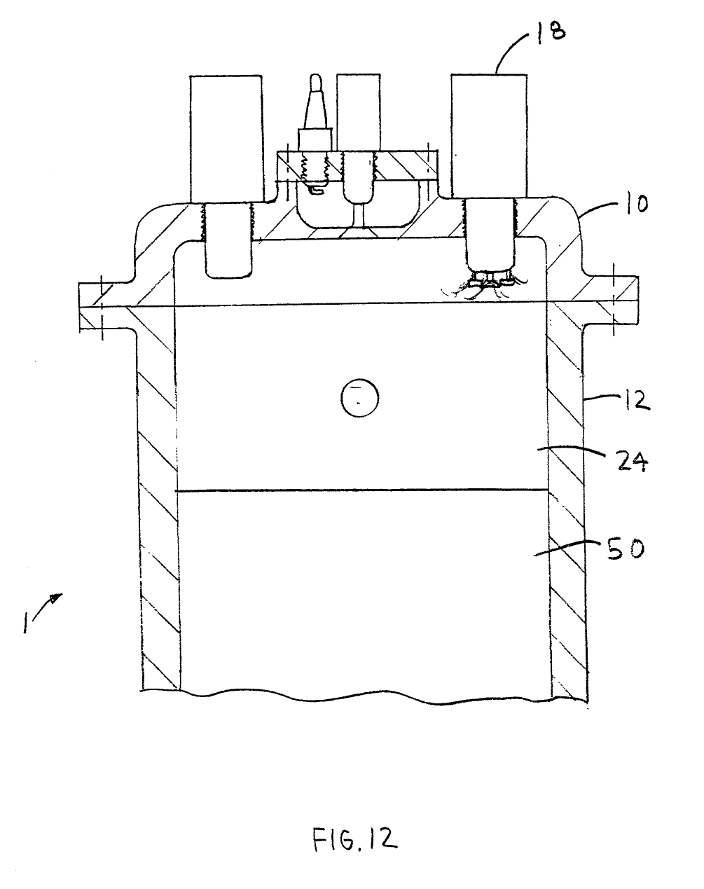

The operation of the hybrid air engine is similar to that of a four cycle internal combustion engine. With reference to FIG. 9, the cylinder 50 is preferably filled with compressed air, atmospheric air and (fuel) from the intake injector 16 on the intake cycle as the piston 24 is on a downward stroke. With reference to FIG. 10, the piston 24 moves upward to compress the air and (fuel) mixture. As the piston 24 reaches a top of a compression stroke, the contents of the precombustion chamber 26 are ignited with the spark plug 28 and the precombustion injector 14 is opened to the cylinder 50. The ignited mixture from the precombustion chamber 26 ignites the contents of the air and (fuel) in the cylinder 50. With reference to FIG. 11, the piston 24 is pushed downward by the ignition on the power stroke. With reference to FIG. 12, the exhaust valve 18 preferably opens at the bottom of the power stroke. The burned air and (fuel) mixture in the cylinder 50 are pushed out as the piston 24 strokes upward on the exhaust stroke. Cool air is injected through the at least one air passage 56 into the cylinder 50 by energizing the outer solenoids 48 as exhaust gases exit the side port 44 of the exhaust valve 18. Preferably during the exhaust stroke, compressed air and optional fuel are injected into the precombustion cavity 34 from the routing manifold 20. Components of the hybrid air engine 1 include injectors, spark plugs, valves, pumps, heater units, and cooler units.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

I claim:

1. A hybrid air engine comprising:
an engine block having at least one cylinder, a reciprocating piston being contained in each of said at least one cylinders;
a head with at least one precombustion chamber, said head with at least one precombustion chamber being attached to said engine block, a single precombustion cavity being formed in each of said at least one precombustion chambers;
at least one intake injector capable of supplying compressed air, said at least one intake injector being retained in said head with at least one precombustion chamber;
means for supply atmospheric air to said cylinder;
a spark plug providing ignition to said precombustion cavity;
said precombustion cavity being supplied with compressed air, said precombustion injector supplying ignited compressed air to a single said at least one cylinder; and
at least one exhaust valve capable of removing exhaust gases from each of said at least one cylinder, said at least one exhaust valve being retained in said head with at least one precombustion chamber.

2. The hybrid air engine of claim 1 wherein:
said means of supplying atmospheric air being contained within each of said at least one intake injectors.

3. The hybrid air engine of claim 1 wherein:
each said at least one exhaust valve containing a center solenoid and at least one outer solenoid, exhaust gases being removed from each said at least one cylinder through said center solenoid, cooled air being injected through said at least one outer solenoid to cool said exhaust valve.

4. The hybrid air engine of claim 1 further comprising:
a routing manifold having at least two inlets and at least two outlets, said routing manifold capable of supplying compressed air and fuel to said at least one intake injectors and said at least one precombustion injectors.

5. The hybrid air engine of claim 4, further comprising:
compressed air and fuel being mixed at each outlet of said routing manifold to each said intake injector and each said precombustion injector, outlet valves controlling the flow of compressed air and fuel to each said outlet.

6. The hybrid air engine of claim 4, further comprising:
a cooler unit and a heater unit being attached to each inlet of said routing manifold.

7. The hybrid air engine of claim 4, further comprising:
a fuel tank containing a supply of fuel;
a fuel pump capable of drawing fuel from said fuel tank and pushing said supply of fuel into said routing manifold;
a fuel input valve controlling the flow of fuel into said fuel pump; and
a fuel output valve controlling the flow of fuel into said routing manifold.

8. The hybrid air engine of claim 4, further comprising:
at least one compressed air tank containing a supply of compressed air;
a compressed air pump capable of drawing compressed air from one of said compressed at least one air tanks and pushing said supply of compressed air into said routing manifold;
an air input valve controlling the flow of compressed air into said compressed air pump; and
an air output valve controlling the flow of compressed air into said routing manifold.

9. The hybrid air engine of claim 1, further comprising:
an engine module capable of controlling components of said hybrid air engine.

10. The hybrid air engine of claim 1, further comprising:
each said at least one intake injector capable of supplying compressed air and fuel.

11. A hybrid air engine comprising:
an engine block having at least one cylinder, a reciprocating piston being contained in each of said at least one cylinders;
a head with at least one precombustion chamber, said head with at least one precombustion chamber being attached to said engine block, a single precombustion cavity being formed in each of said at least one precombustion chambers;
at least one intake injector capable of supplying compressed air, fuel and atmospheric air, said at least one intake injector being retained in said head with precombustion chamber;
a spark plug providing ignition to said precombustion cavity;
a precombustion cavity being supplied with compressed air and fuel, said precombustion injector capable of supplying ignited compressed air and fuel to a single said at least one cylinders;
at least one exhaust valve capable of removing exhaust gases from each of said at least one cylinders, said at least one exhaust valve being retained in said head with at least one precombustion chamber;
a routing manifold having at least two inlets and at least two outlets for receiving and supplying compressed air and fuel;
an engine module capable of controlling components of said hybrid air engine.

12. The hybrid air engine of claim 11 wherein:
said exhaust valve containing a center solenoid and at least one outer solenoid, exhaust gases being removed from each said at least one cylinder through said center solenoid, cooled air being injected through said at least one outer solenoid to cool said exhaust valve.

13. The hybrid air engine of claim 11 wherein:
said routing manifold capable of supplying compressed air and fuel to said at least one intake injectors and said at least one precombustion injectors.

14. The hybrid air engine of claim 13, further comprising:
compressed air and fuel being mixed at each outlet of said routing manifold to each said intake injector and each said precombustion injector, outlet valves controlling the flow of compressed air and fuel to each said outlet.

15. The hybrid air engine of claim 13, further comprising:
a cooler unit and a heater unit being attached to each inlet of said routing manifold.

16. The hybrid air engine of claim 13, further comprising:
a fuel tank containing a supply of fuel;
a fuel pump capable of drawing fuel from said fuel tank and pushing said supply of fuel into said routing manifold;
a fuel input valve controlling the flow of fuel into said fuel pump; and
a fuel output valve controlling the flow of fuel into said routing manifold.

17. The hybrid air engine of claim 13, further comprising:
at least one compressed air tank containing a supply of compressed air;
a compressed air pump capable of drawing compressed air from one of said compressed air tanks and pushing said supply of compressed air into said routing manifold;
an air input valve controlling the flow of compressed air into said compressed air pump; and
an air output valve controlling the flow of compressed air into said routing manifold.

18. A method of increasing the power output of an air engine, comprising the steps of:
(a) creating at least one precombustion chamber in a head of said air engine;
(b) supplying each said precombustion chamber with a quantity of compressed air;
(c) igniting said quantity of compressed air to form an ignited mixture, supplying said ignited mixture to a cylinder of said engine at a specified time; and
(d) supplying compressed air to said cylinder on an intake stroke, said ignited mixture being used to ignite said compressed air supplied to said cylinder.

19. A method of increasing the power output of an air engine of claim 18 wherein:
a quantity of fuel being supplied with said compressed air to said cylinder when extra power is required.

20. A method of increasing the power output of an air engine of claim 18 wherein:
a quantity of fuel being supplied with said compressed air to said precombustion chamber when extra power is required.

21. An injector comprising:
an injector body;
a center solenoid being contained in said injector body, said center solenoid opening a center valve when energized; and
at least one outer solenoid being contained in said injector body, each said outer solenoid valve opening a semi-circular valve when energized.
